(19) United States
(12) Patent Application Publication
(10) Pub. No.: US 2021/0261435 A1
(43) Pub. Date: Aug. 26, 2021

(54) ENVIRONMENTAL PROTECTION FILTER APPARATUS FOR REMOVING ODOR FROM DOMESTIC SEWAGE BASED ON MICROBIAL REACTION

(71) Applicant: CHI LUN NG, Hong Kong (CN)

(72) Inventor: CHI LUN NG, Hong Kong (CN)

(21) Appl. No.: 17/100,973

(22) Filed: Nov. 23, 2020

(30) Foreign Application Priority Data
Feb. 25, 2020 (CN) 202010115455.3

(51) Int. Cl. C02F 1/00; C02F 9/00

(52) U.S. Cl. CPC C02F 1/001; C02F 9/00; C02F 2303/02; C02F 2201/005; C02F 2301/08; C02F 2001/007

(57) ABSTRACT

The application discloses an environmental protection filter apparatus for removing odor from domestic sewage based on microbial reaction, which includes a tank body and a separating device. An internal space of the tank body is divided into a sedimentation cavity, an oxidation cavity and a filter cavity from top to bottom by a first partition plate and a second partition plate. The separating device includes a fixed block fixedly connected with an inner wall of the tank body and located in the sedimentation cavity, a scraping block fitted against a side wall of the fixed block and a driving motor provided on a top of the tank body. An output end of the driving motor extends into the tank body and is connected with the scraping block. An inner wall of the sedimentation cavity is provided with a stopper fixedly connected with the tank body.

### TECHNICAL FIELD

The disclosure relates to a technical field of sewage treatment, in particular to an environmental protection filter apparatus for removing odor from domestic sewage based on microbial reaction.

### BACKGROUND ART

Currently, a sewage treatment device available on the market is with a large footprint and a low filtration efficiency. Meanwhile, because there are many solid impurities such as garbage in urban domestic sewage, it is often prone to be blocked for a filter hole of a filter device during a filtration, which affects a filtration efficiency; and if this case continues for a long period, it is easy to cause apparatus damage and a high maintenance cost. In addition, if the filter device is cleaned manually, it is difficult to operate, is with a high labor cost, and only scratches the surface of a problem.

In view of this, it is particularly important to develop and design an environmental protection filter apparatus for removing odor from domestic sewage based on microbial reaction, which can solve the above technical problems.

### SUMMARY

An object of the disclosure is to provide an environmental protection filter apparatus for removing odor from domestic sewage based on microbial reaction, which has characteristics of being capable of intercepting solid impurities, high filtration efficiency and low cost.

The disclosure provides a technical scheme as follows.

In a first aspect, the embodiment of the disclosure provides an environmental protection filter apparatus for removing odor from domestic sewage based on microbial reaction, which includes a tank body and a separating device.

The tank body is vertically arranged. A water inlet pipe for the sewage to flow in is provided on a top of the tank body, a first partition plate and a second partition plate are sequentially provided in the tank body from top to bottom, and an internal space of the tank body is divided into a sedimentation cavity, an oxidation cavity and a filter cavity from top to bottom by the first partition plate and the second partition plate. A water outlet pipe communicated with the filter cavity is provided at a lower end of an outer wall of the tank body.

The separating device includes a fixed block, a scraping block and a driving motor. The fixed block is fixedly connected with an inner wall of the tank body and located in the sedimentation cavity, the scraping block is fitted against a side wall of the fixed block, and the driving motor which is arranged vertically downward is provided on a top of the tank body. An output end of the driving motor extends into the tank body and is connected with the scraping block. An inner wall of the sedimentation cavity is provided with a stopper fixedly connected with the tank body. The driving motor can drive the scraping block to rotate to the stopper, so that the solid impurities are separated into a space between the fixed block and the scraping block.

Combined with the first aspect, in a first implementation of the first aspect, a first control device for controlling a flow of the sewage from the sedimentation cavity to the oxidation cavity is provided at a bottom of the first partition plate.

Combined with the first aspect and the above implementation, in a second implementation of the first aspect, an air inlet pipe communicated with the oxidation cavity is provided in the outer wall of the tank body respectively.

Combined with the first aspect and the above implementations, in a third implementation of the first aspect, the first control device includes a first water flow pipe which is provided at the bottom of the first partition plate and fixedly connected therewith, and a first solenoid valve which controls an opening and closing of the first water flow pipe.

Combined with the first aspect and the above implementations, in a fourth implementation of the first aspect, a second control device for controlling a flow of the sewage from the oxidation cavity to the filter cavity is provided at a bottom of the second partition plate.

Combined with the first aspect and the above implementations, in a fifth implementation of the first aspect, the first control device includes a second water flow pipe which is provided at a bottom of the second partition plate and fixedly connected therewith, and a second solenoid valve which controls an opening and closing of the second water flow pipe.

Combined with the first aspect and the above implementations, in a sixth implementation of the first aspect, a filter device for filtering the sewage for multiple times is provided in the filter cavity.

Combined with the first aspect and the above implementations, in a seventh implementation of the first aspect, the filter device includes a first filter screen layer, a second filter screen layer and a third filter screen layer which are arranged in the filter cavity at intervals and in parallel.

Bottoms of the first filter screen layer, the second filter screen layer and the third filter screen layer are each provided with a plurality of support blocks for their installation, rear ends of all of the support blocks are fixedly connected with the inner wall of the tank body and each support block is fixedly connected with the first filter screen layer, the second filter screen layer and the third filter screen layer through bolts.

Combined with the first aspect and the above implementations, in an eighth implementation of the first aspect, a notch is defined in the outer wall of the tank body, and a drawing plate which is insertion-fitted with the notch is provided in the outer wall of the tank body.

Combined with the first aspect and the above implementations, in a ninth implementations of the first aspect, an outer wall of the drawing plate is provided with a handle part fixedly connected therewith, the drawing plate is of an arc structure and plug blocks fixedly connected with the drawing plate are provided at both ends of the drawing plate, and slots which are insertion-fitted with the plug blocks are provided on the tank body.

Compared with the prior art, the environmental protection filter apparatus for removing odor from domestic sewage based on microbial reaction provided in embodiments of the disclosure has the following beneficial effects:

The water inlet pipe for the sewage to flow in is provided on the top of the tank body, the first partition plate and the second partition plate are sequentially provided in the tank body from top to bottom, and the internal space of the tank body is divided into the sedimentation cavity, the oxidation cavity and the filter cavity from top to bottom by the first partition plate and the second partition plate. The water outlet pipe communicated with the filter cavity is provided at the lower end of an outer wall of the tank body. The separating device includes the fixed block, the scraping block and the driving motor. The fixed block is fixedly connected with the inner wall of the tank body and located in the sedimentation cavity, the scraping block is fitted against the side wall of the fixed block, and the driving motor which is arranged vertically downward is provided on the top of the tank body. The output end of the driving motor extends into the tank body and is connected with the scraping block. The inner wall of the sedimentation cavity is provided with a stopper fixedly connected with the tank body. The driving motor can drive the scraping block to rotate to the stopper, so that the solid impurities are separated into a space between the fixed block and the scraping block. In this way, the sewage flows into the sedimentation cavity through the water inlet pipe and is subjected to a sedimentation process, so that a large amount of impurities and garbage in the sewage settle at a bottom of the sedimentation cavity, and the scraping block fixedly connected with the driving motor, along with the impurities and garbage, is driven by the driving motor to rotate to the stopper to divide the sedimentation cavity into two spaces, so that the impurities and garbage are separated from the sedimentation processed sewage and left in the space between the fixed block and the scraping block, which facilitates a centralized treatment of the impurities and garbage later; after being filtered by the tank body, the filtered sewage flows out of the water outlet pipe. In this way, the solid impurities are directly intercepted by a physical manner and a filtration efficiency is high; and meanwhile because of its simple structure and without ease of causing blockage and damage to the apparatus, a maintenance cost is low, and thus the environmental protection filter apparatus for removing odor from the domestic sewage based on the microbial reaction is with a low cost.

In order to make the above objects, features and advantages of the present disclosure more obvious and easy to understand, a detailed description will be made below to the preferred embodiments in conjunction with the drawings.

### BRIEF DESCRIPTION OF DRAWINGS

In order to explain technical schemes of the embodiments of the present disclosure more clearly, the drawings used in the embodiment will be briefly introduced below. It should be understood that the following drawings only illustrate certain embodiments of the present disclosure, and therefore should not be regarded as limiting the scope thereof. For those skilled in the art, other related drawings can be obtained according to these drawings without paying any creative labor.

FIG. 1 is a structural view of an environmental protection filter apparatus for removing odor from domestic sewage based on microbial reaction provided in an embodiment of the present disclosure at a first perspective.

FIG. 2 is a schematic sectional view of an environmental protection filter apparatus for deodorizing domestic sewage based on microbial reaction provided in an embodiment of the present disclosure.

FIG. 3 is a structural view of an environmental protection filter apparatus for removing odor of domestic sewage based on microbial reaction provided in an embodiment of the present disclosure, with a sedimentation cavity partially sectioned.

FIG. 4 is a structural schematic diagram of an environmental protection filter apparatus for removing odor from domestic sewage based on microbial reaction provided in an embodiment of the present disclosure at a second perspective.

FIG. 5 is a structural view of an environmental protection filter apparatus for removing odor from domestic sewage based on microbial reaction provided in an embodiment of the present disclosure with a drawing plate opened.

Reference Number: 1—tank body; 1a—Slot; 2—First Partition; 3—Second Partition; 4—Sedimentation Cavity; 5—Oxidation Cavity; 6—Filter Cavity; 7—Separating Device; 7a—Fixed Block; 7b—Scraping Block; 7c—Driving Motor; 7d—Stopper; 8—First Control Device; 8a—First Water Flow Pipe; 8b—First Solenoid Valve; 9—Second Control Device; 9a—Second Water Flow Pipe; 9b—Second Solenoid Valve; 10—Filter Device; 10a—First Filter Screen Layer; 10b—Second Filter Layer; 10c—Third Filter Layer; 10d—Support Block; 11—Drawing Plate; 12—Water Inlet Pipe; 13—Water Outlet Pipe; 14—Handle Part; 15—Plug Block.

### DETAILED DESCRIPTION OF PREFERRED EMBODIMENTS

In order to make the objects, technical schemes and advantages of the embodiments of the present disclosure more clear, the technical schemes in the embodiments of the present disclosure will be described clearly and completely in combination with the drawings in the embodiments of the present disclosure. Obviously, the described embodiments are some, but not all, of the embodiments of the present disclosure. Generally, components of the embodiments of the present disclosure described and illustrated in the drawings herein may be arranged and designed in various different configurations.

It should be noted that similar reference numbers and letters indicate similar items in the following figures, and thus once an item is defined in one figure, it is not necessary to further define and explain it in the following figures. Orientations or positional relationships indicated by the terms “upper”, “lower”, “inner”, “outer”, “left” and “right” or the like are based on orientations or positional relationships shown in the drawings, or orientations or positional relationships that a product of the present disclosure are usually placed in use, or orientations or positional relationships that are commonly understood by those skilled in the art, which is only for convenience of describing the present disclosure and for simplifying the description, but is not intended to indicate or imply that the referenced apparatus or element must be in a particular orientation, configured or operated in a particular orientation, and thus should not to be construed as limiting the present disclosure. The terms “first”, “second”, etc. are only used to distinguish descriptions, and cannot be understood as indicating or implying a relative importance. Terms “comprising”, “including” or any other variation thereof are intended to encompass a non-exclusive inclusion, so that a process, method, article or apparatus including a series of elements includes not only those elements, but also other elements not explicitly listed, or elements inherent to such process, method, article or apparatus. Without further restrictions, an element defined by the statement “includes a . . . ” does not exclude presence of other identical elements in the process, method, article or apparatus including the element.

It should also be noted that unless otherwise specified and limited, terms such as “providing” and “connecting” should be understood in a broad sense. For example, “connecting” can be a fixed connection, a detachable connection, or an integral connection; or can be a mechanical or electrical connection; or can be a direct connection, or an indirect connection through an intermediate medium, or can be a communication inside two elements. For a person of ordinary skill in the art, specific meanings of the above terms in the present disclosure can be understood according to specific situations.

The specific embodiments of the present disclosure will be described in detail in combination with the drawings.

### Embodiments

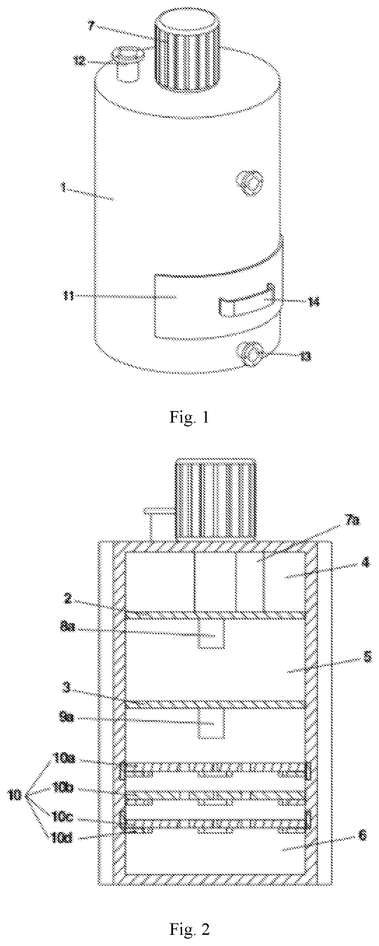

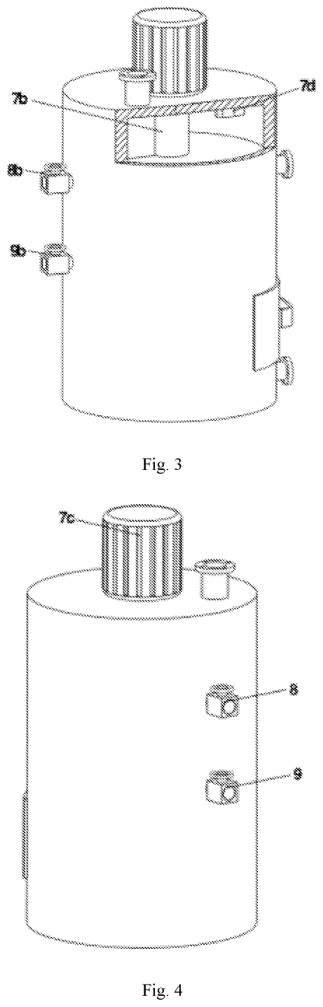

Please refer to FIGS. 1, 2 and 3, FIG. 1 is a structural view of an environmental protection filter apparatus for removing odor from domestic sewage based on microbial reaction provided in an embodiment of the present disclosure at a first perspective. FIG. 2 is a schematic sectional view of an environmental protection filter apparatus for deodorizing domestic sewage based on microbial reaction provided in an embodiment of the present disclosure. FIG. 3 is a structural view of an environmental protection filter apparatus for removing odor of domestic sewage based on microbial reaction provided in an embodiment of the present disclosure, with a sedimentation cavity 4 partially sectioned.

The disclosure provides an environmental protection filter apparatus for removing odor from domestic sewage based on microbial reaction, which has characteristics of being capable of intercepting solid impurities, high filtration efficiency and low cost. The environmental protection filter apparatus for removing odor from the domestic sewage based on the microbial reaction can be applied to situations such as filtering of the domestic sewage, river water.

A structure constitute, a working principle and beneficial effects of the environmental protection filter apparatus for removing odor from the domestic sewage based on the microbial reaction provided in the embodiment of the present disclosure will be specifically introduced in the following.

The environmental protection filter apparatus for removing odor from the domestic sewage based on the microbial reaction includes a tank body 1 and a separating device 7. The tank body 1 is vertically arranged. A water inlet pipe 12 for the sewage to flow in is provided on a top of the tank body 1, a first partition plate 2 and a second partition plate 3 are sequentially provided in the tank body 1 from top to bottom, and an internal space of the tank body 1 is divided into a sedimentation cavity 4, an oxidation cavity 5 and a filter cavity 6 from top to bottom by the first partition plate 2 and the second partition plate 3. A water outlet pipe 13 communicated with the filter cavity 6 is provided at a lower end of an outer wall of the tank body 1. The separating device 7 includes a fixed block 7a, a scraping block 7b and a driving motor 7c. The fixed block 7a is fixedly connected with an inner wall of the tank body 1 and located in the sedimentation cavity 4, the scraping block 7b is fitted against a side wall of the fixed block 7a, and the driving motor 7c which is arranged vertically downward is provided on a top of the tank body 1. An output end of the driving motor 7c extends into the tank body 1 and is connected with the scraping block 7b. An inner wall of the sedimentation cavity 4 is provided with the stopper 7d fixedly connected with the tank body 1. The driving motor 7c can drive the scraping block 7b to rotate to the stopper 7d, so that the solid impurities are separated into a space between the fixed block 7a and the scraping block 7b.

In this way, the sewage flows into the sedimentation cavity 4 through the water inlet pipe 12 and is subjected to a sedimentation process, so that a large amount of impurities and garbage in the sewage settle at a bottom of the sedimentation cavity 4, and the scraping block 7b fixedly connected with the driving motor 7c, along with the impurities and garbage, is driven by the driving motor to rotate to the stopper 7d to divide the sedimentation cavity 4 into two spaces, so that the impurities and garbage are separated from the sedimentation processed sewage and left in the space between the fixed block 7a and the scraping block 7b, which facilitates a centralized treatment of the impurities and garbage later; after being filtered by the tank body 1, the filtered sewage flows out of the water outlet pipe 13. In this way, the solid impurities are directly intercepted by a physical manner and a filtration efficiency is high; and meanwhile because of its simple structure and without ease of causing blockage and damage to the apparatus, a maintenance cost is low, and thus the environmental protection filter apparatus for removing odor from the domestic sewage based on the microbial reaction is with a low cost.

It should be noted that the scraping block 7b and/or the fixed block 7a are defined with filter holes for the sewage to pass through.

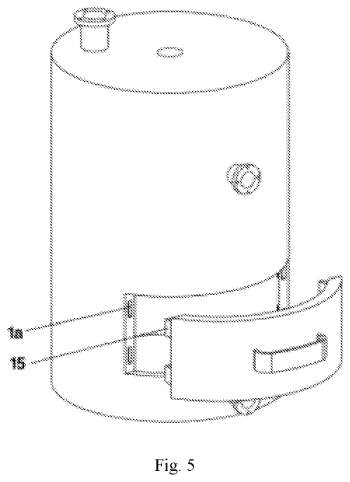

Please referring to FIGS. 1-5, FIG. 4 is a structural schematic diagram of an environmental protection filter apparatus for removing odor from domestic sewage based on microbial reaction provided in an embodiment of the present disclosure at a second perspective. FIG. 5 is a structural view of an environmental protection filter apparatus for removing odor from domestic sewage based on microbial reaction provided in an embodiment of the present disclosure with a drawing plate 11 opened.

Further, a first control device 8 for controlling a flow of the sewage from the sedimentation cavity 4 to the oxidation cavity 5 is provided at a bottom of the first partition plate 2, so as to control the flow of the sewage and improve automation of the apparatus.

Furthermore, an air inlet pipe communicated with the oxidation cavity 5 is provided in the outer wall of the tank body 1 respectively. Oxygen can be introduced into the air inlet pipe to provide oxygen needed for respiration of microbes in the sewage, so that the microbes can digest dirt in the sewage and further treat the sewage.

It should be noted that the first control device 8 may include a first water pipe 8a which is provided at the bottom of the first partition plate 2 and fixedly connected therewith, and a first solenoid valve 8b which controls an opening and closing 32 of the first water flow pipe 8a. The sewage can flow into the oxidation cavity 5 through the first solenoid valve 8b, the oxygen can be introduced into the air inlet pipe to provide the oxygen needed for respiration of microbes in the sewage, so that the microbes can digest dirt in the sewage and further treat the sewage.

Further, a second control device 9 for controlling a flow of the sewage from the oxidation cavity 5 to the filter cavity 6 is provided at a bottom of the second partition plate 3, so as to control the flow of the sewage and improve the automation of the apparatus.

Further, the first control device 9 includes a second water flow pipe 9a which is provided at a bottom of the second partition plate 3 and fixedly connected therewith, and a second solenoid valve 9b which controls an opening and closing of the second water flow pipe 9a. In this way, the sewage flows into the filter cavity 6 through the second solenoid valve 9b.

Further, a filterer device 10 for filtering the sewage for multiple times may be provided in the filter cavity 6.

It should be noted that in this embodiment, the filter device 10 includes a first filter screen layer 10a, a second filter screen layer 10b and a third filter screen layer 10c which are arranged in the filter cavity 6 at intervals and in parallel. Bottoms of the first filter screen layer 10a, the second filter screen layer 10b and the third filter screen layer 10c are each provided with a plurality of support blocks 10d for their installation, rear ends of all of the support blocks 10d are fixedly connected with the inner wall of the tank body 1 and each support block 10d is fixedly connected with the first filter screen layer 10a, the second filter screen layer 10b and the third filter screen layer 10c through bolts. The first filter layer 10a is used for a coarse filtration of the sewage, the second filter layer 10b is used for a fine filtration of the sewage, and activated carbon can be provided in the third filter layer 10c so that fine particles and odor in the sewage can be absorbed and filtered with the third filter layer 10c. In other embodiments, the filtering device 10 can also be of other types of multi-layer filtering structures.

Furthermore, a notch is defined in the outer wall of the tank body 1, and a drawing plate 11 which is insertion-fitted with the notch is provided in the outer wall of the tank body 1. The notch corresponds to the filter device 10, which facilitates maintaining the environmental protection filter apparatus for removing odor from the domestic sewage based on the microbial reaction through the notch.

Furthermore, an outer wall of the drawing plate 11 is provided with a handle part 14 fixedly connected therewith, the drawing plate 11 is of an arc structure and plug blocks 15 fixedly connected with the drawing plate are provided at both ends of the drawing plate 11, and slots la which are insertion-fitted with the plug blocks 15 are provided on the tank body 1. A regular maintenance and replacement of the first filter screen layer 10a, the second filter screen layer 10b and the third filter screen layer 10c can be realized with an insertion-fitting between the drawing plate 11 and the tank body 1.

Generally speaking, in this embodiment, the environmental protection filter apparatus for removing odor from the domestic sewage based on the microbial reaction includes a vertically arranged tank body 1 in which the first partition 2 and the second partition 3 are arranged in parallel and at intervals, the internal space of the tank body 1 is divided into the sedimentation cavity 4, the oxidation cavity 5 and the filter cavity 6 by the first partition 2 and the second partition 3, and the separating device 7 is provided in the sedimentation cavity 4 to separate sediments from the sewage. The first control device 8 for controlling the flow of the sewage from the sedimentation cavity 4 to the oxidation cavity 5 is provided at the bottom of the first partition plate 2, and the second control device 9 for controlling the flow of the sewage from the oxidation cavity 5 to the filter cavity 6 is provided at the bottom of the second partition plate 3. The filterer device 10 for filtering the sewage for multiple times is provided in the filter cavity 6. The notch for facilitating the replacement and maintenance of the filter device 10 is defined in the outer wall of the tank body 1, and the drawing plate 11 which is insertion-fitted with the notch is provided in the outer wall of the tank body 1. The water inlet pipe 12 for the sewage to flow in is provided at the top of the tank body 1, and the air inlet pipe communicated with the oxidation cavity 5 and the water outlet pipe 13 communicated with the filtration cavity 6 are respectively provided in the outer wall of the tank body 1.

The separating device 7 includes the fixed block 7a which is fixedly connected with the inner wall of the tank body 1 and located in the sedimentation cavity 4, and the scraping block 7b which is fitted against the side wall of the fixed block 7a. The driving motor 7c which is arranged vertically downward is provided on the top of the tank body 1. The output end of the driving motor 7c passes through the tank body 1 and is connected with the rear end of the scraping block 7b. The inner wall of the sedimentation cavity 4 is provided with the stopper 7d fixedly connected with the tank body 1.

The filter device 10 includes the first filter screen layer 10a, the second filter screen layer 10b and the third filter screen layer 10c which are arranged in the filter cavity 6 at intervals and in parallel. Bottoms of the first filter screen layer 10a, the second filter screen layer 10b and the third filter screen layer 10c are each provided with a plurality of support blocks 10d for their installation, rear ends of all of the support blocks 10d are fixedly connected with the inner wall of the tank body 1 and each support block 10d is fixedly connected with the first filter screen layer 10a, the second filter screen layer 10b and the third filter screen layer 10c through bolts.

When the filter apparatus works, the sewage flows into the sedimentation cavity 4 through the water inlet pipe 12 and is subjected to the sedimentation process, so that a large number of impurities and garbage in the sewage settle at the bottom of the sedimentation cavity 4, and the scraping block 7b fixedly connected with the driving motor 7c, along with the impurities and garbage, is driven by the driving motor to rotate to the stopper 7d to divide the sedimentation cavity 4 into two spaces, so that the impurities and garbage are separated from the sedimentation processed sewage, which facilitates the centralized treatment of the impurities and garbage later. The sewage can flow into the oxidation cavity 5 through the first solenoid valve 8b, the oxygen can be introduced into the air inlet pipe to provide the oxygen needed for respiration of microbes in the sewage, so that the microbes can digest dirt in the sewage and further treat the sewage. The sewage flows into the filter cavity 6 through the second solenoid valve 9b, and the first filter layer 10a is used for the coarse filtration of the sewage, the second filter layer 10b is used for the fine filtration of the sewage, and the third filter layer 10c is used to absorb and filter fine particles and odor in the sewage, and the filtered sewage flows out of the water outlet pipe 13. The regular maintenance and replacement of the first filter screen layer 10a, the second filter screen layer 10b and the third filter screen layer 10c can be realized with an insertion-fitting between the drawing plate 11 and the tank body 1.

A working principle of the environmental protection filter apparatus for removing odor from the domestic sewage based on the microbial reaction is as follows.

The water inlet pipe 12 for the sewage to flow in is provided on the top of the tank body 1, the first partition plate 2 and the second partition plate 3 are sequentially provided in the tank body 1 from top to bottom, and the internal space of the tank body 1 is divided into the sedimentation cavity 4, the oxidation cavity 5 and the filter cavity 6 from top to bottom by the first partition plate 2 and the second partition plate 3. The water outlet pipe 13 communicated with the filter cavity 6 is provided at the lower end of an outer wall of the tank body 1. The separating device 7 includes the fixed block 7a, the scraping block 7b and the driving motor 7c. The fixed block 7a is fixedly connected with the inner wall of the tank body 1 and located in the sedimentation cavity 4, the scraping block 7b is fitted against the side wall of the fixed block 7a, and the driving motor 7c which is arranged vertically downward is provided on the top of the tank body 1. The output end of the driving motor 7c extends into the tank body 1 and is connected with the scraping block 7b. The inner wall of the sedimentation cavity 4 is provided with the stopper 7d fixedly connected with the tank body 1. The driving motor 7c can drive the scraping block 7b to rotate to the stopper 7d, so that the solid impurities are separated into a space between the fixed block 7a and the scraping block 7b. In this way, the sewage flows into the sedimentation cavity 4 through the water inlet pipe 12 and is subjected to a sedimentation process, so that a large amount of impurities and garbage in the sewage settle at a bottom of the sedimentation cavity 4, and the scraping block 7b fixedly connected with the driving motor 7c, along with the impurities and garbage, is driven by the driving motor to rotate to the stopper 7d to divide the sedimentation cavity 4 into two spaces, so that the impurities and garbage are separated from the sedimentation processed sewage and left in the space between the fixed block 7a and the scraping block 7b, which facilitates a centralized treatment of the impurities and garbage later; after being filtered by the tank body 1, the filtered sewage flows out of the water outlet pipe 13. In this way, the solid impurities are directly intercepted by a physical manner and a filtration efficiency is high; and meanwhile because of its simple structure and without ease of causing blockage and damage to the apparatus, a maintenance cost is low, and thus the environmental protection filter apparatus for removing odor from the domestic sewage based on the microbial reaction is with a low cost.

To sum up:

The embodiments of the disclosure provide an environmental protection filter apparatus for removing odor from domestic sewage based on microbial reaction, which has characteristics of being capable of intercepting solid impurities, high filtration efficiency and low cost.

The above is only preferred embodiments of the present disclosure, and is not intended to limit the present disclosure. For those skilled in the art, the features in the above embodiments can be combined with each other and modification and variations can be made to the present disclosure without conflict.

1. An environmental protection filter apparatus for removing odor from domestic sewage based on microbial reaction, comprising a tank body (1) and a separating device (7); wherein
the tank body (1) is vertically arranged, a water inlet pipe (12) for the sewage to flow in is provided on a top of the tank body (1), a first partition plate (2) and a second partition plate (3) are sequentially provided in the tank body (1) from top to bottom, an internal space of the tank body (1) is divided into a sedimentation cavity (4), an oxidation cavity (5) and a filter cavity (6) from top to bottom by the first partition plate (2) and the second partition plate (3), and a water outlet pipe (13) communicated with the filter cavity (6) is provided at a lower end of an outer wall of the tank body (1); and
the separating device (7) comprises a fixed block (7a), a scraping block (7b) and a driving motor (7c), the fixed block (7a) being fixedly connected with an inner wall of the tank body (1) and located in the sedimentation cavity (4), the scraping block (7b) being fitted against a side wall of the fixed block (7a), and the driving motor (7c) which is arranged vertically downward being provided on a top of the tank body (1), an output end of the driving motor (7c) extending into the tank body (1) and being connected with the scraping block (7b), an inner wall of the sedimentation cavity (4) being provided with a stopper (7d) fixedly connected with the tank body (1), and the driving motor (7c) being capable of driving the scraping block (7b) to rotate to the stopper (7d), so that the solid impurities are separated into a space between the fixed block (7a) and the scraping block (7b).

2. The environmental protection filter apparatus for removing odor from the domestic sewage based on the microbial reaction according to claim 1, wherein a first control device (8) for controlling a flow of the sewage from the sedimentation cavity (4) to the oxidation cavity (5) is provided at a bottom of the first partition plate (2).

3. The environmental protection filter apparatus for removing odor from the domestic sewage based on the microbial reaction according to claim 2, wherein an air inlet pipe communicated with the oxidation cavity (5) is provided in the outer wall of the tank body (1).

4. The environmental protection filter apparatus for removing odor from the domestic sewage based on the microbial reaction according to claim 3, wherein the first control device (8) comprises a first water flow pipe (8a) which is provided at the bottom of the first partition plate (2) and fixedly connected therewith, and a first solenoid valve (8b) which controls an opening and closing (32) of the first water flow pipe (8a).

5. The environmental protection filter apparatus for removing odor from the domestic sewage based on the microbial reaction according to claim 1, wherein a second control device (9) for controlling a flow of the sewage from the oxidation cavity (5) to the filter cavity (6) is provided at a bottom of the second partition plate (3)

6. The environmental protection filter apparatus for removing odor from the domestic sewage based on the microbial reaction according to claim 5, wherein the second control device (9) comprises a second water flow pipe (9a) which is provided at the bottom of the second partition plate (3) and fixedly connected therewith, and a second solenoid valve (9b) which controls an opening and closing (32) of the second water flow pipe (9a).

7. The environmental protection filter apparatus for removing odor from the domestic sewage based on the microbial reaction according to claim 1, wherein a filter device (10) for filtering the sewage for multiple times is provided in the filter cavity (6).

8. The environmental protection filter apparatus for removing odor from the domestic sewage based on the microbial reaction according to claim 7, wherein the filtering device (10) comprises a first filter screen layer (10a), a second filter screen layer (10b) and a third filter screen layer (10c) which are arranged in the filter cavity (6) at intervals and in parallel; and
bottoms of the first filter screen layer (10a), the second filter screen layer (10b) and the third filter screen layer (10c) are each provided with a plurality of support blocks (10d) for their installation, rear ends of all of the support blocks (10d) are fixedly connected with the inner wall of the tank body (1) and each support block (10d) is fixedly connected with the first filter screen layer (10a), the second filter screen layer (10b) and the third filter screen layer (10c) through bolts.

9. The environmental protection filter apparatus for removing odor from the domestic sewage based on the microbial reaction according to claim 1, wherein a notch is defined in the outer wall of the tank body (1), and a drawing plate (11) which is insertion-fitted with the notch is provided in the outer wall of the tank body (1).

10. The environmental protection filter apparatus for removing odor from the domestic sewage based on the microbial reaction according to claim 9, wherein an outer wall of the drawing plate (11) is provided with a handle part (14) fixedly connected therewith, the drawing plate (11) is of an arc structure and plug blocks (15) fixedly connected with the drawing plate are provided at both ends of the drawing plate (11), and slots (1a) which are insertion-fitted with the plug blocks (15) are provided on the tank body (1).
